(19) United States
(12) Patent Application Publication
(10) Pub. No.: US 2014/0195284 A1
(43) Pub. Date: Jul. 10, 2014

(54) Computerized System and Method for Business Process Modeling and Testing

(71) Applicant: SYNTEL, INC, TROY, MI (US)

(72) Inventors: Deepak Purandare, Talawade Pune (IN); Priya Padmanabhan Lakshmanan, Chennai (IN)

(21) Appl. No.: 14/066,760

(22) Filed: Oct. 30, 2013

Related U.S. Application Data
(60) Provisional application No. 61/720,629, filed on Oct. 31, 2012.

(51) Int. Cl. G06Q 10/06

(52) U.S. Cl. CPC G06Q 10/063
USPC 705/7.11

(57) ABSTRACT

A computerized system and method for building a business process test repository. This repository could be used to test and optimize business processes in an organization. In many cases, the test cases in the repository may be reused for different applications and/or products. Embodiments of the system develop test cases from a domain point of view and not from the application point of view. In some such embodiments, the test cases would not refer to any application, application user interface, screens, or user interface events, but would be from the vantage point of business actions. The test cases in the repository could be taken as a basis for starting a testing effort and customizing the test case for the application specific details.

### RELATED APPLICATIONS

This application claims the benefit of U.S. Provisional Application Ser. No. 61/720,629, filed Oct. 31, 2012, which is hereby incorporated by reference in its entirety.

### TECHNICAL FIELD

This invention relates generally to a computerized system and method for modeling and testing business processes.

### BACKGROUND AND SUMMARY

A business process is generally thought of as a collection of related, structured activities or tasks that produce a specific service or product for a particular customer or customers. The business process shows how the activities are sequenced, who the stake holders are, what information flows through, and what alternate flows the information passes through depending upon the intermediate evaluations at the decision points.

Business processes modeling is an important step during enterprise business modeling. Enterprise business modeling may be required to evaluate how the business functions in order to find out the redundancies and improve the operational efficiencies. Also, the process modeling is an essential step while mapping business processes. This gives an idea of how the logical to physical mapping has happened and which are the spots that may provide scope for optimization.

According to one embodiment, business process modeling may be used to capture a domain understanding about a business process, which becomes the base for a variety of services offerings including domain-based testing services. For example, the system may be configured to provide a domain-based testing service that is formulated in a structured way using industry standards enabling maximum reusability. In some cases, domain-based assets are no longer value adds, they have become qualifiers.

According to another embodiment, the system includes a business process and test repository (“BPTR”). For example, the BPTR could be a domain centric service offering for a variety of industries, such as for the insurance domain. In some embodiments, a domain based BPTR is formed from the insurance industry's best practices, but is not specific to any insurer or application. This could be used to prove the domain capabilities and a product specific BPTR for a leading insurance enterprise product that accelerates test design.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1A is a diagram showing steps that may be taken to generate test cases for a business process according to an embodiment of the invention;

FIG. 1B is a diagram of an embodiment of a system by which the business processes and test repositories illustrated in FIG. 1A could be developed;

FIGS. 2A and 2B illustrate an example business process diagram that could be created using the system according to one embodiment of the invention;

FIG. 3 is an example matrix of business artifacts that could be derived from the business process diagram according to one embodiment of the invention;

FIG. 4 is an example test case that could be used to validate a business process;

FIG. 5 is a diagram showing possible actions that may be taken to convert generic test cases to product specific test cases according to one embodiment of the invention;

FIGS. 6A-6C illustrate a diagram showing an example business process diagram mapping sheet with unique tasks and expected results for a process flow according to one embodiment of the invention;

FIG. 7 is a diagram showing example user definable fields and values that could be provided for test cases according to one embodiment of the invention;

FIG. 8 is a screenshot showing a list of example test cases selected by the user from an entire list of test cases according to one embodiment of the invention;

FIGS. 9A and 9B illustrate an example product specific business process diagram that could be created using the system according to one embodiment of the invention;

FIGS. 10A and 10B illustrate an example matrix of business artifacts that could be derived from the business process diagram according to one embodiment of the invention;

FIG. 11 is an example test case that could be used to validate a business process according to one embodiment of the invention;

FIGS. 12 and 13 show the product BPTR customization framework with the field configuration details;

FIG. 14 is a screenshot showing a sample of test cases generated for field validations according to one embodiment of the invention;

FIG. 15 is a screenshot showing an association of business rules with each of the fields according to one embodiment of the invention; and

FIG. 16 is a matrix showing testing roles and permissions generated for test cases to test the permissions associated with the roles.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

According to one embodiment, this disclosure provides a computerized system and method for building a business process test repository and uses this repository to test and optimize business processes in an organization. In many cases, the test cases in the repository may be reused for different applications and/or products. For example, embodiments of the system develop test cases from a domain point of view and not from the application point of view. In such embodiments, the test cases would not refer to any application, application user interface, screens, or user interface events, but would be from the vantage point of business actions. For example, the test cases in the repository could be taken as a basis for starting a testing effort and customizing the test case for the application specific details. Well documented business processes will act not only as sales tool, but also to give software architects, designers, and developers a good head start into structuring the effort well. The repository could act as a baseline for business processes and important business functions and provide a way to capture the business requirements in structured fashion. Also, it provides a platform to plan the logical to physical mapping from the application development point of view. The software provides the benefit of optimizing business processes for performance by removing redundancies in business operations. Although the system will be generally described in terms of developing a test repository and optimizing business processes in the insurance industry, this is not intended to limit this disclosure in any way to a particular industry or field. One skilled in the art should appreciate that the system described herein could be used in conjunction with business processes of any industry.

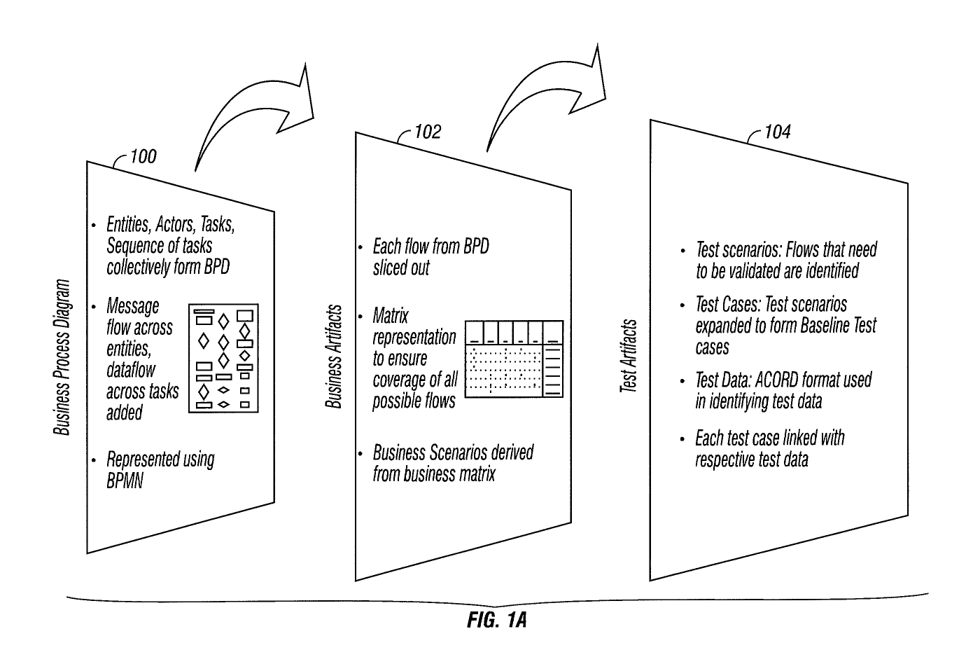

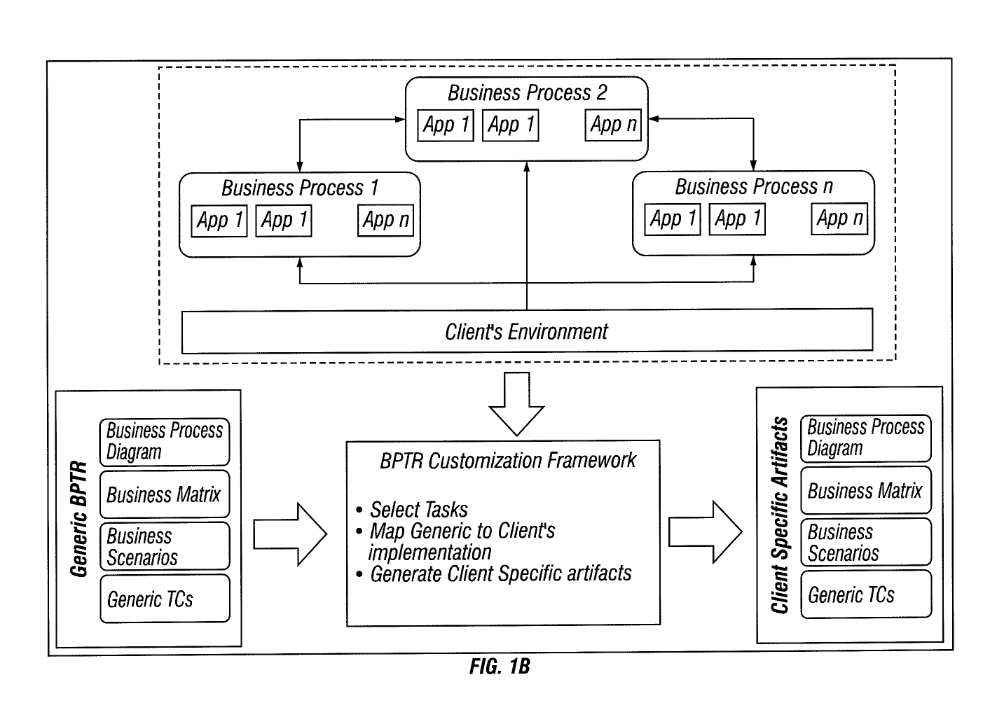

FIGS. 1A and 1B are diagrams illustrating a method and system respectively by which a business processes and tests repository (“BPTR”) could be developed according to one embodiment. In this example, a business process diagram 100 is created for a business process. For example, this may include various information about the process, such as the entities, actors, tasks, sequence of tasks, message flow across entities, various decisions made in a business process, and data flow across tasks.

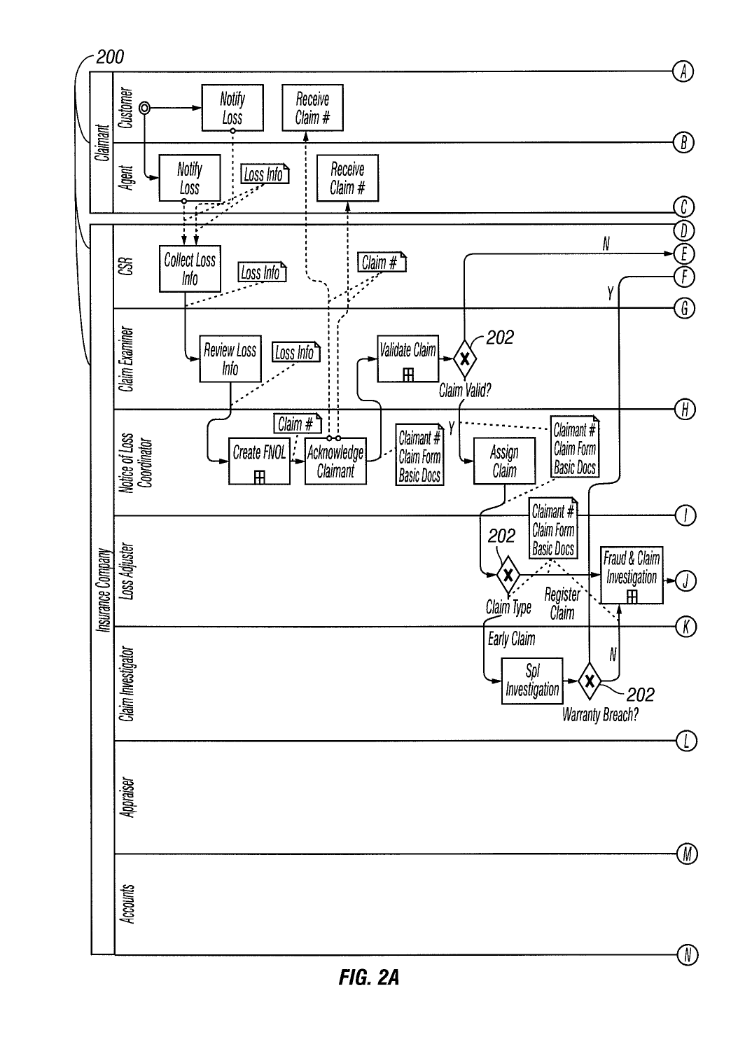

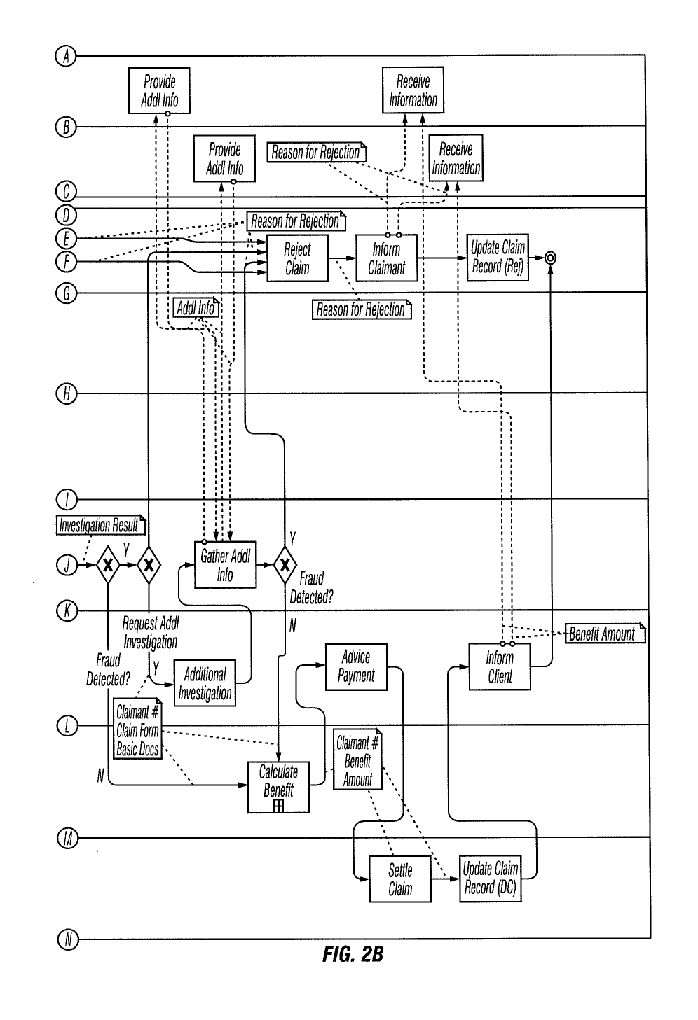

FIGS. 2A and 2B illustrate an example business process diagram that could be created. In this example, the business process diagram includes a plurality of actors or entities 200, such as customer, agent, etc., that are involved in the process. This shows the data flow throughout the process and the plurality of decision points that may be made throughout the process. Although this shows one possible graphical manner by which the business process diagram could be shown, other manners by which the process could be graphically represented are also contemplated.

The business artifacts 102 represented by the business process can then be developed. For example, each flow from the business process diagram could be sliced out, such as using a matrix to ensure coverage of all possible flows. Various scenarios that may be encountered in the business process could be derived from the matrix.

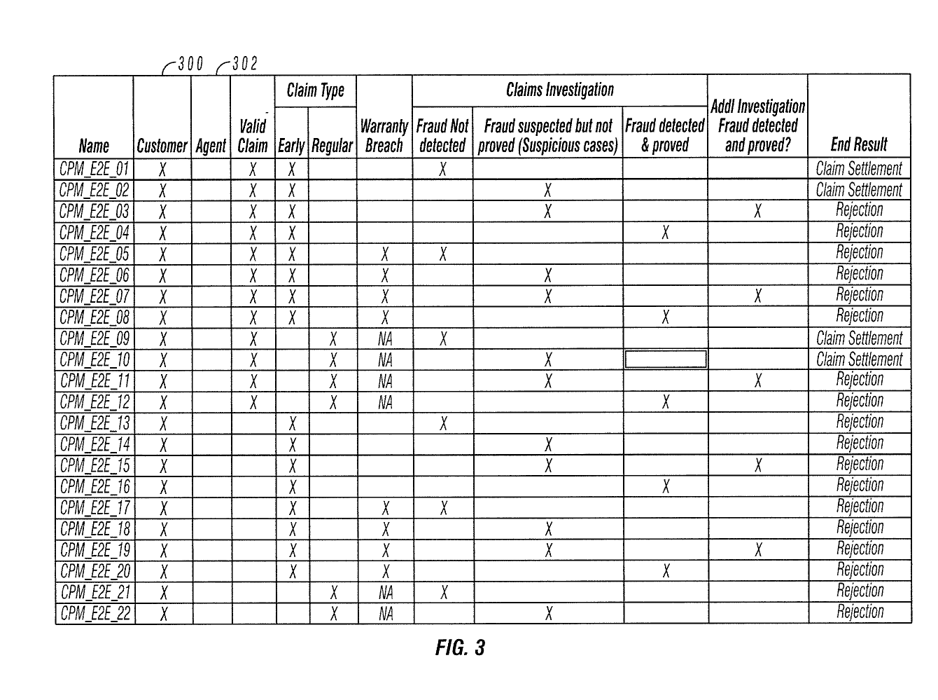

FIG. 3 is an example matrix that could be used to show business artifacts. As shown, at least one actor is shown in the matrix, which is a customer and an actor in this example. Many of the columns in the matrix can be taken from the decision points in the business process diagram, which ensures all possible flows in the matrix.

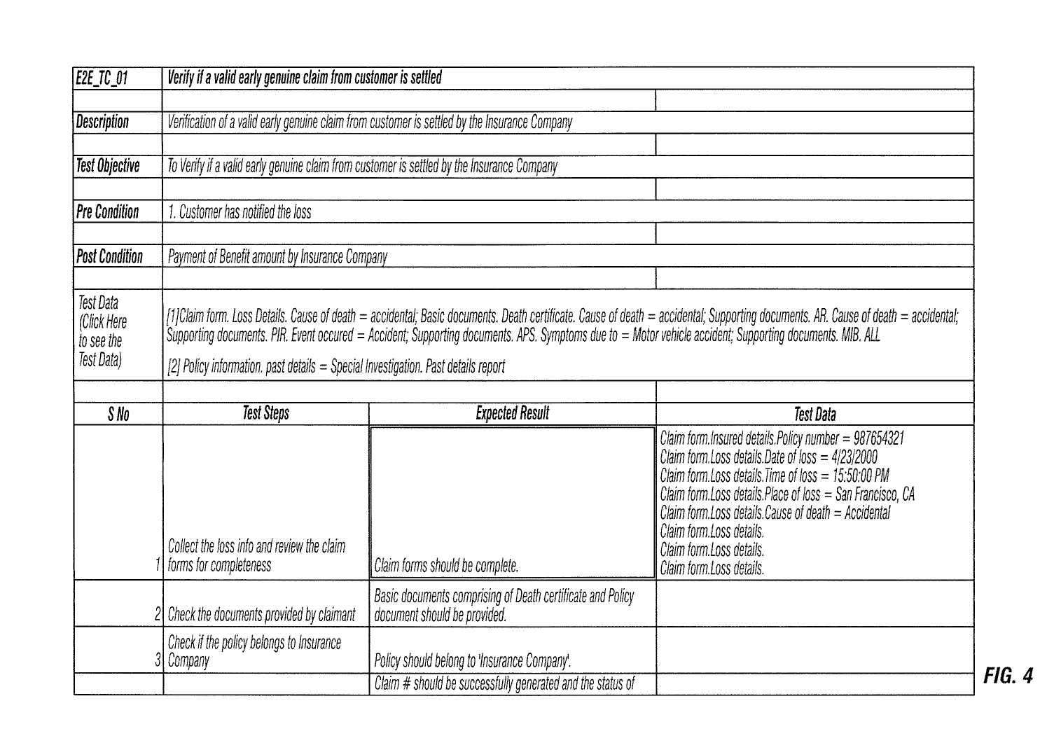

This allows the creation of test artifacts 104, which includes identification of test scenarios for flows that need to be validated. Baseline test cases can be created using test scenarios. Typically, the test data is formatted as identifying test data according to an industry standard, such as an ACORD® standard in the case of the insurance industry. Each test case may be linked with respective test data. FIG. 4 is an example test case that could be used to validate a business process.

Though the underlying business process remains the same across all the industry, the way the business process gets implemented in each product used by several corporations would be different. For example, this would involve changes in screens, fields, navigations, field types etc. Testing engagements deal with test design and test execution for these products configured for business processes. Both test design and test execution phases require product knowledge and domain knowledge to be effective. To accomplish effective test design, the generic base-lined domain driven test artifacts in BPTR can be converted to product based repository using the BPTR Customization Framework.

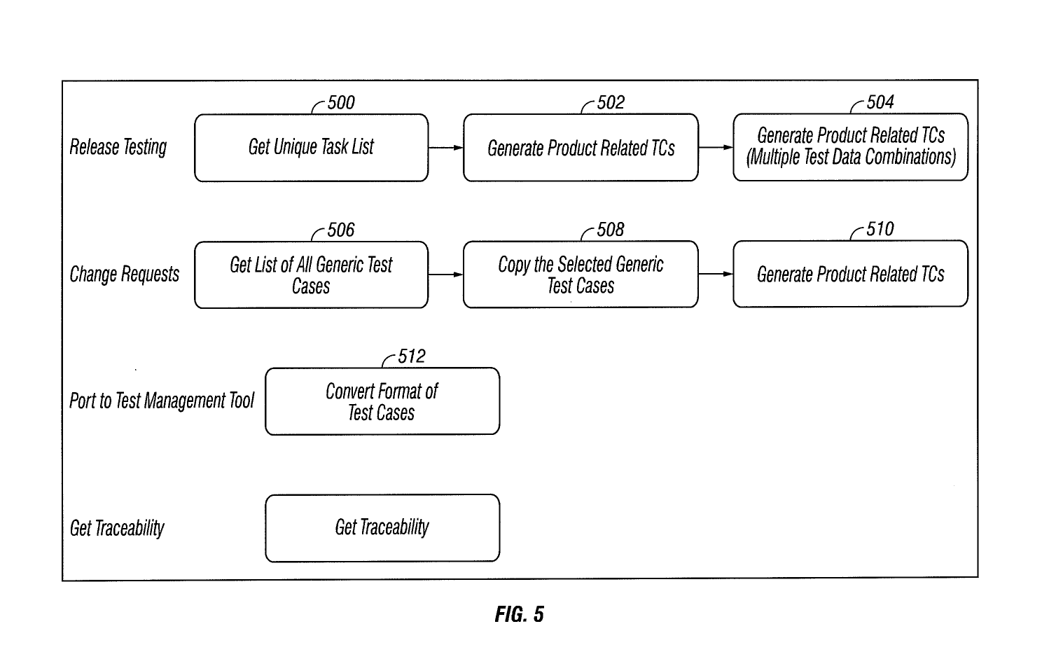

In one embodiment, the BPTR Customization Framework is a Microsoft Excel-based solution that has been built with a set of visual basic scripts to perform the actions required to convert the generic test cases to product specific test cases. Although Microsoft Excel is used for purposes of explanation, other software could be used in conjunction with the BPTR customization framework. FIG. 5 shows various controls in the framework used for the conversion process. In this example, release testing involves getting a unique task list 500 and generating product related test cases 502. This allows generation of product related test cases with multiple test data combinations 504. This example customization framework also includes a process to handle change requests. In this example, a list of all generic test cases is retrieved 506. The selected generic test cases are copied 508 and product related test cases are generated 510. The test cases could be ported to a test management tool 512.

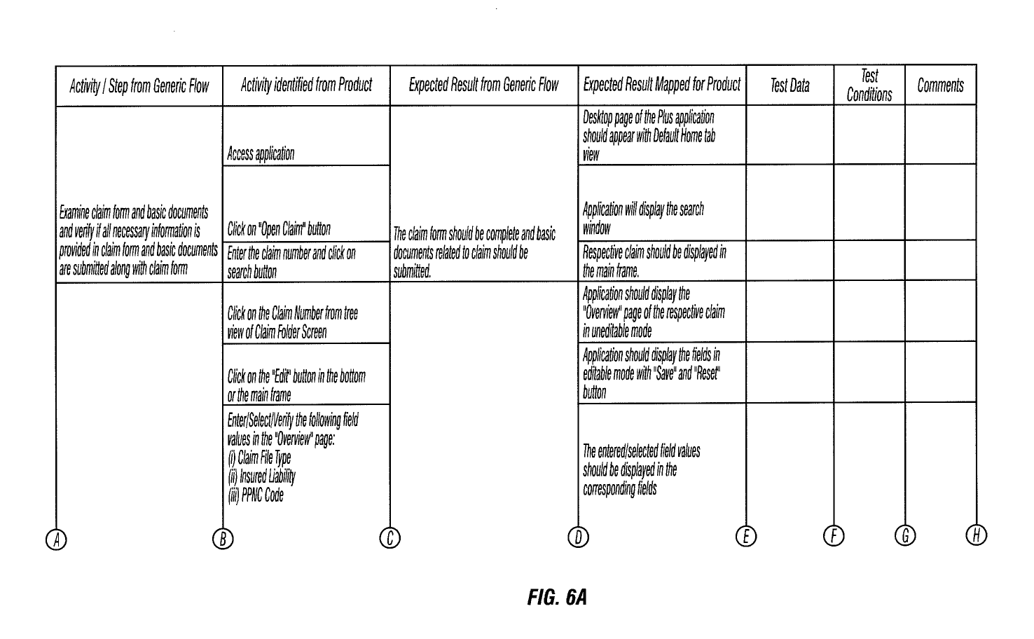

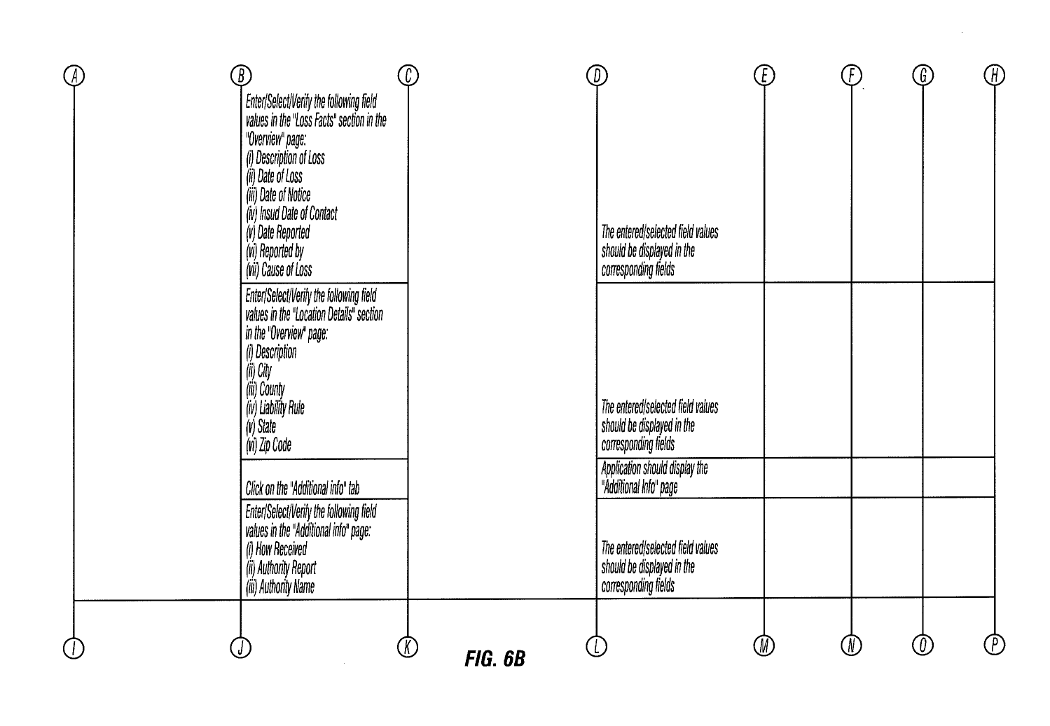

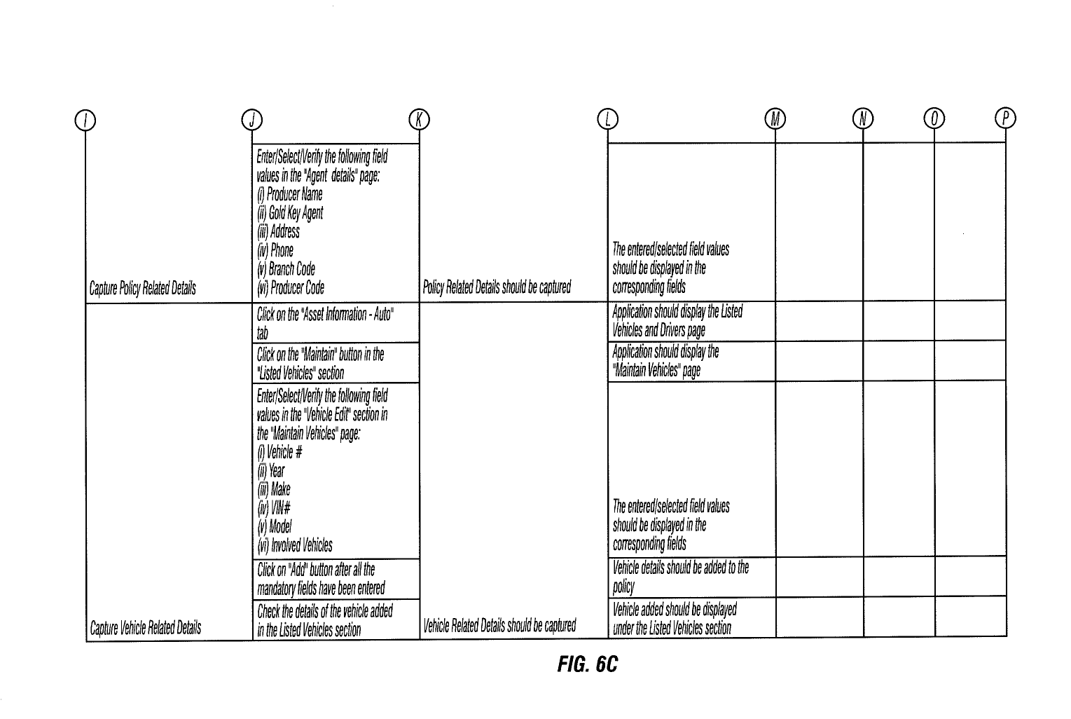

To create product based test artifacts, a unique set of tasks is taken from the generic test repository. In some embodiments, clicking the button “Get Unique Task List” gets all the unique test steps and expected results. Each unique test step and expected result corresponds to the action to be performed in order to accomplish the process flow. All the unique test steps and expected results are mapped to the action the user needs to do in the product in the BPD mapping sheet. FIGS. 6A-6C show a sample mapping.

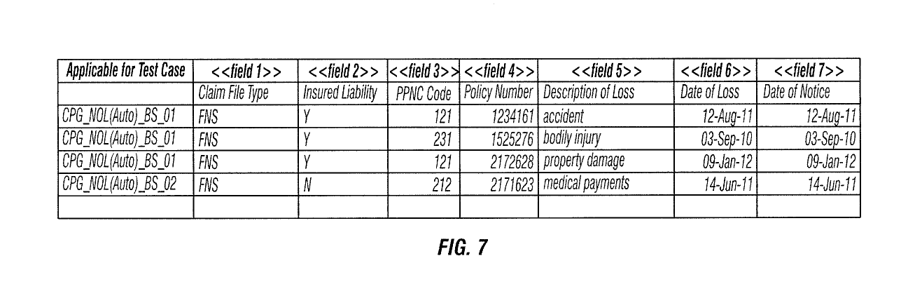

Once mapping is done, the system is configured to convert all the generic test cases to product related test cases, such as by clicking the “Generate Product Related Test cases (TCs)” in some embodiments. In order to provide the test data for all test cases, the user may define the fields and values in the field configurations, such as shown in FIG. 7. In some embodiments, clicking “Generate Product Related TCs (Multiple Test Data Combinations)” will map all test data combinations for a specific test case.

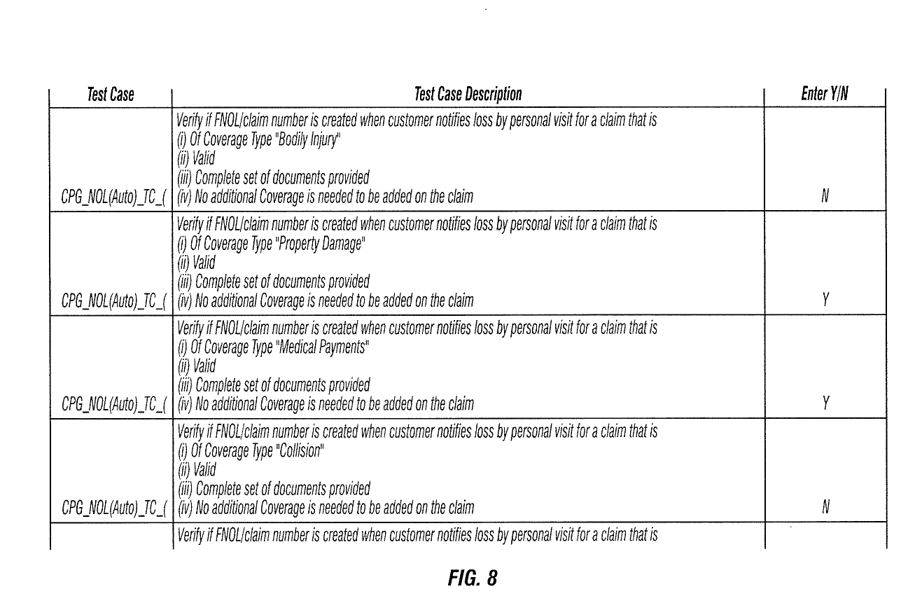

The system is also configured to handle change requests. If the user needs to generate product specific test cases for only few generic test cases, the user should first select the test cases of interest from the entire list. This may be achieved by clicking “Get list of All Generic test cases” and “Copy the Selected Generic Test cases” button in some embodiments. FIG. 8 shows selected test cases from the complete list. The change request that has happened at the process level is done at the BPD mapping sheet for the corresponding test step and the expected result and the test cases are re-generated using, in one embodiment, the “Generate Product Related TCs” button.

To complete the above tasks and generate product specific TCs, the user would analyze the business processes at the customer's environment and compare it with the existing business processes to understand the customer specific requirements. The applicable generic artifacts would be listed down and then would be mapped to the customer implementation specific details to generate the product test cases.

In one embodiment specific to the insurance industry, the domain knowledge related to Insurance is captured in structured form. The business processes, important activities, the activities sequencing, the information that flows through the system is captured well in structured form. Adoption of industry standards (e.g., Business Process and Modeling Notations [BPMN], Association of Cooperative and Operative Research and Development [ACORD]) helps with standardization of the processes. This gives us baseline on domain knowledge that can be used on customer engagements to see the variations in processes and suggest optimizations. This will work as accelerators in new customer engagements for product implementation, product building, and product customization. This provides an advantage as business processes can be used/reused, which provides a shorter learning curve for ramping up the workforce on the domain skills very fast and ensures effective testing is achieved from a business perspective and provides optimal test coverage.

The business process based test repository created for the products using the BPTR methodology/approach explained above could be used as accelerators during test design phase in conjunction with third party products. For example, third party products, such as Guidewire and Duckcreek, have proven to be the most widely used enterprise applications. Insurers are moving towards Guidewire and Duckcreek products from legacy systems and the BPTR approach could be used as accelerators for purposes of testing in conjunction with those products or other third party products. The overall approach taken for creation of product specific business processes based test repository is generally the same as the domain based BPTR. Testing tools could be built based on this approach and used in conjunction with a testing platform to test business processes, such as in conjunction with third party products.

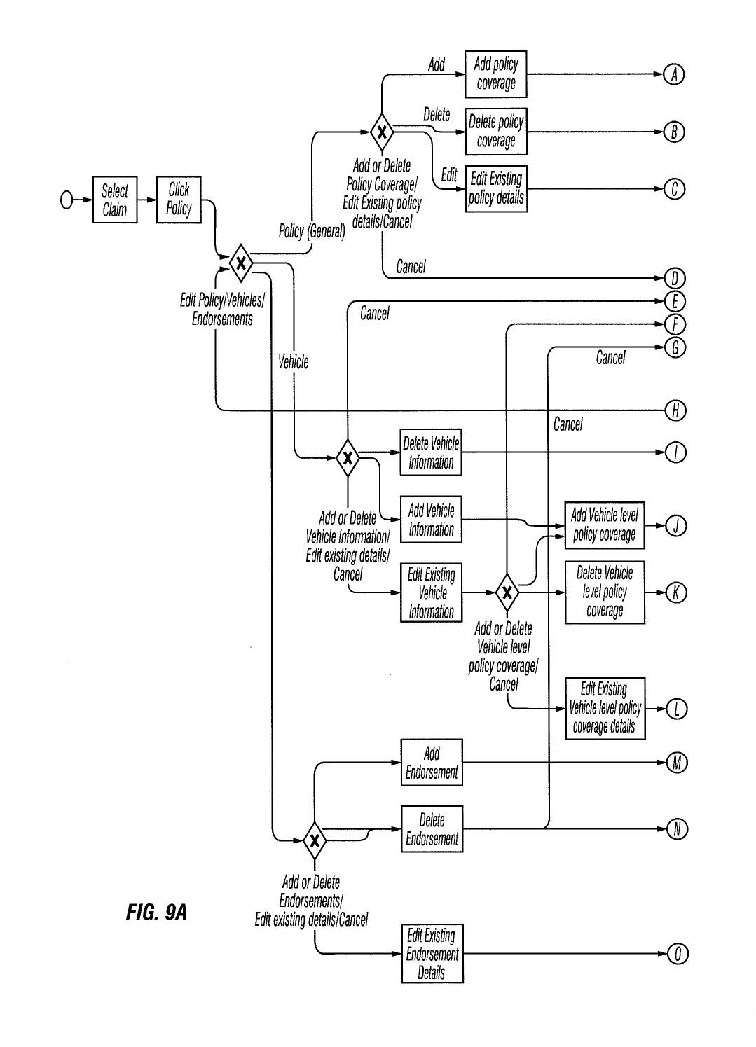

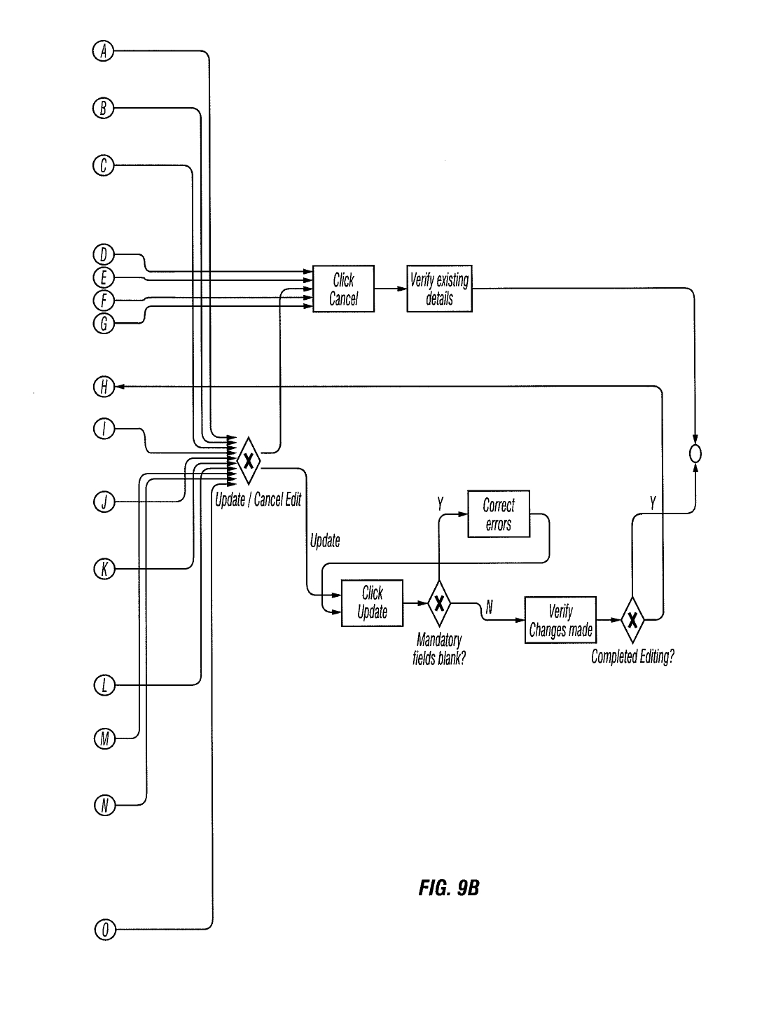

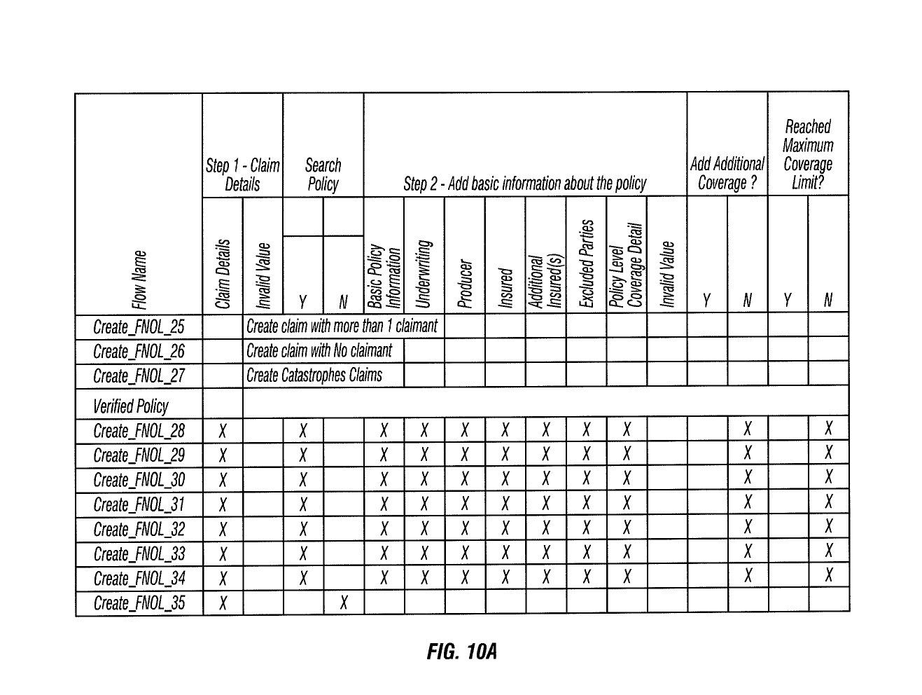

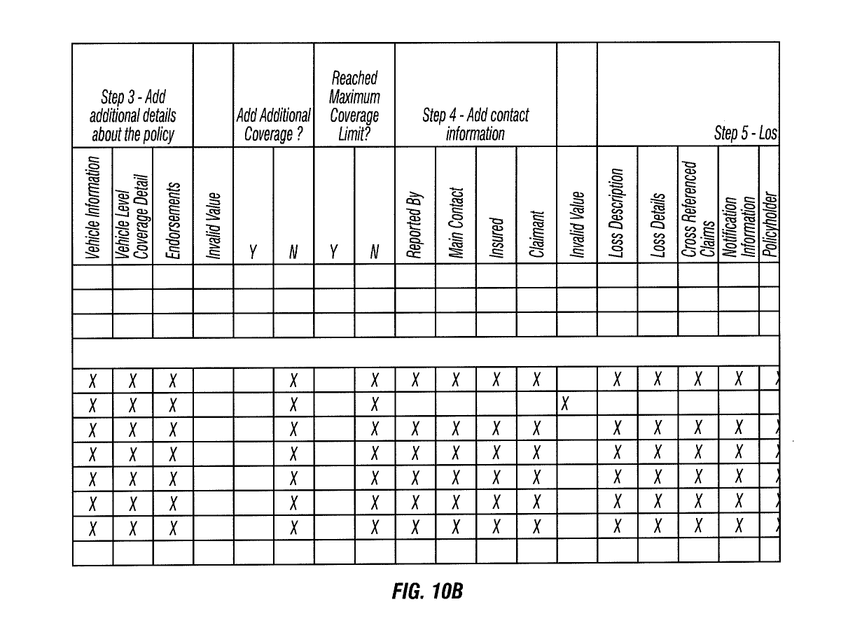

Below is a list of activities done to come up with the business process diagrams and business artifacts specific to the products according to some embodiments:
Product functional analysis: Analyze application for functionality and flows and identify interaction between screens and modules. Gather details on information flow.
Create Business Process Diagram: Identify flows, stakeholders, activities, sequence of activities, decision points and data flow. Represent the flow using BPMN and prepare Business Process Diagram (BPD). Compare the BPD with that of application's flow and update the changes.
Create Business Artifacts: Create Matrix covering all the unique flows and arrive at the business scenarios from the matrix.
FIGS. 9A and 9B illustrate an example business process diagram. FIGS. 10A and 10B illustrate an example matrix that could be used to show business artifacts.
From the Business Process Repository, the following activities were done in one embodiment to create the test artifacts:
Create the Test Scenarios
Expand the test scenario into test cases by providing the preconditions, post-conditions, test steps in the test scenario and expected result
Baseline the test artifacts

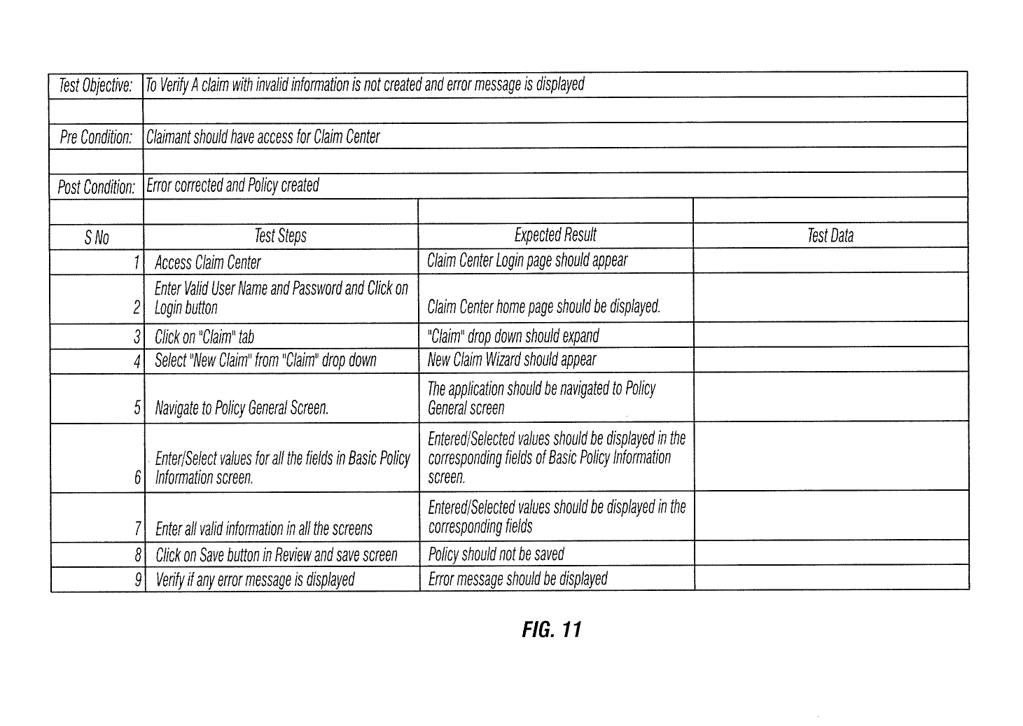

FIG. 11 is an example test case that could be used to validate a business process.

In some embodiments, customizing an enterprise application/product to an organization's needs includes:
a) Changing field names,
b) Adding a new field to a screen,
c) Deleting an existing field from the screen,
d) Making a field mandate or not,
e) Making a field editable or not,
f) Changing the field type to dropdown from text,
g) Adding/Delete a section consisting of multiple fields,
h) Adding/Delete/Change roles and permission of different users, and
i) Adding/Delete/Change business rules associated with the fields.

When organizations prefer customizing the Guidewire application to their needs, it would directly impact the test repository that was created by taking a baseline screen. To address this, customization of test cases is done through Product BPTR Customization Framework as explained below.

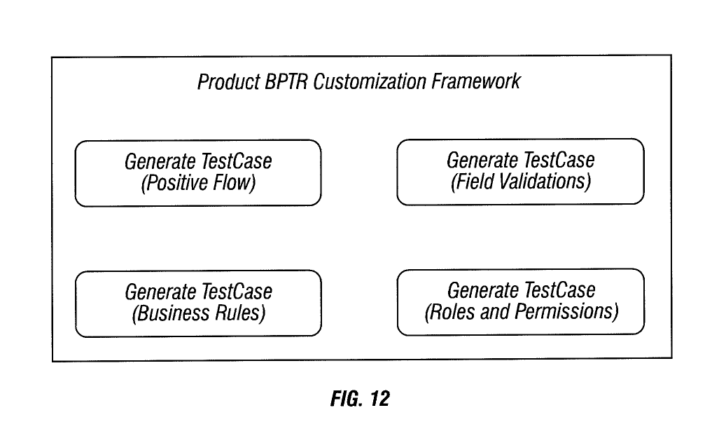

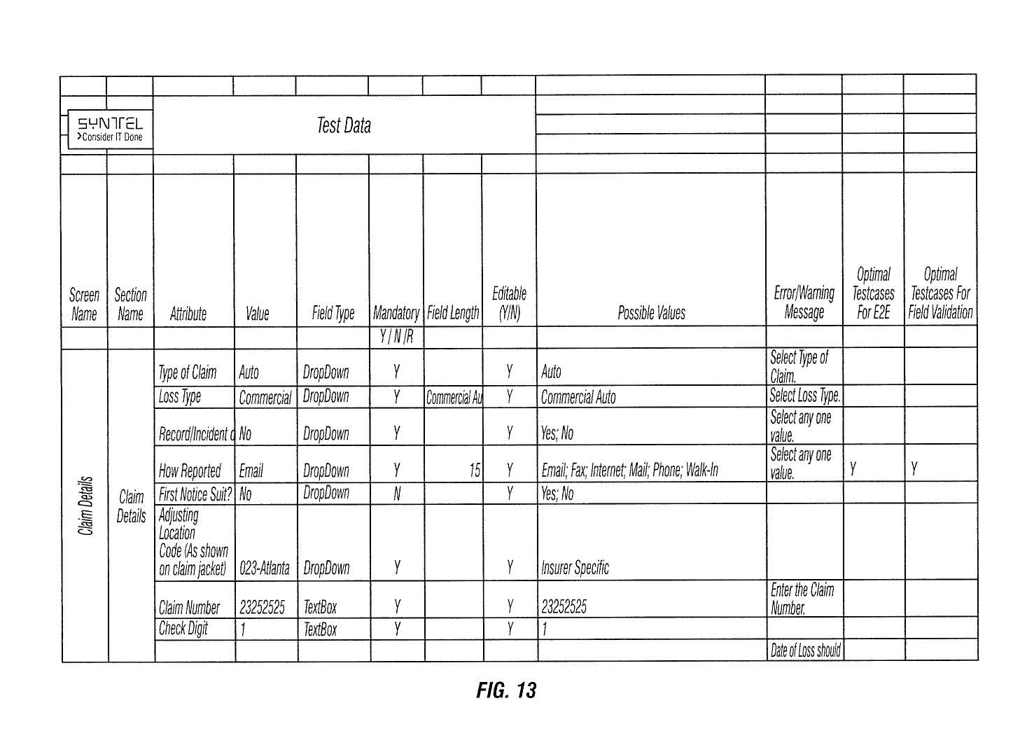

In one embodiment, the product BPTR customization framework is an Excel-based solution that takes in the screen, field configurations, business rules, UI, field related information, roles for the specific module as input and creates test cases for:
(i) Positive flow
(ii) Negative/Alternate flow
(iii) UI/Field Validations
(iv) Business Rules configured for the product
(v) Roles configured for the product
   As discussed above, this disclosure is not intended to be limited to use of Microsoft Excel, but other software could be used in conjunction with the BPTR customization framework. FIGS. 12 and 13 show the product BPTR customization framework with the field configuration details.

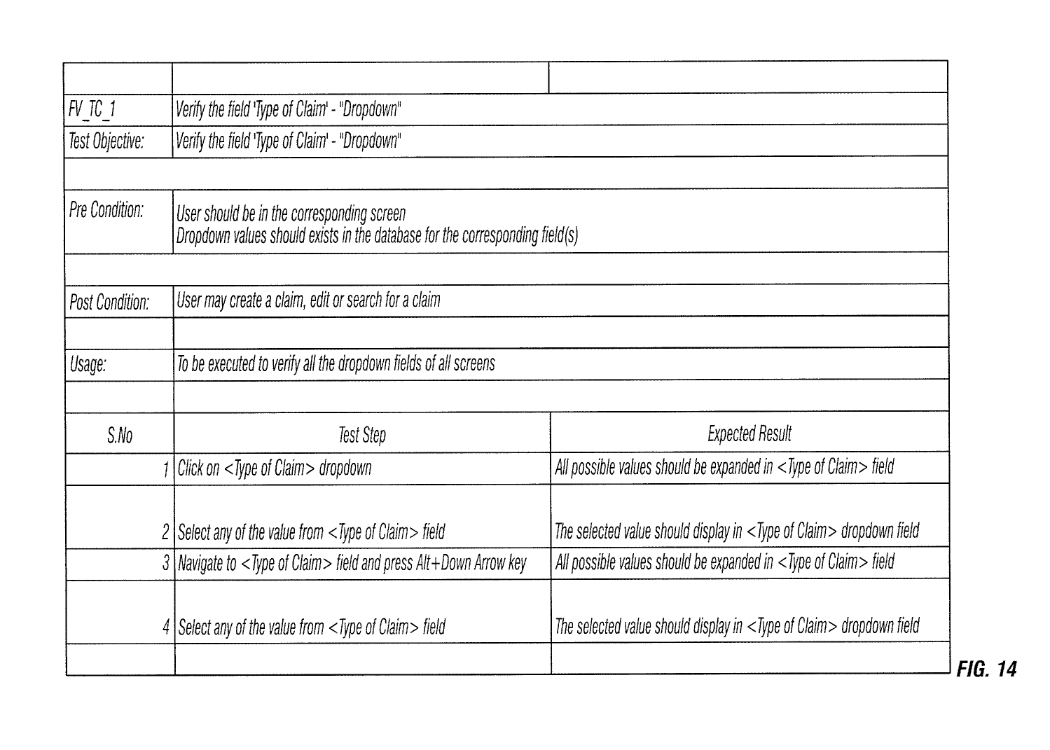

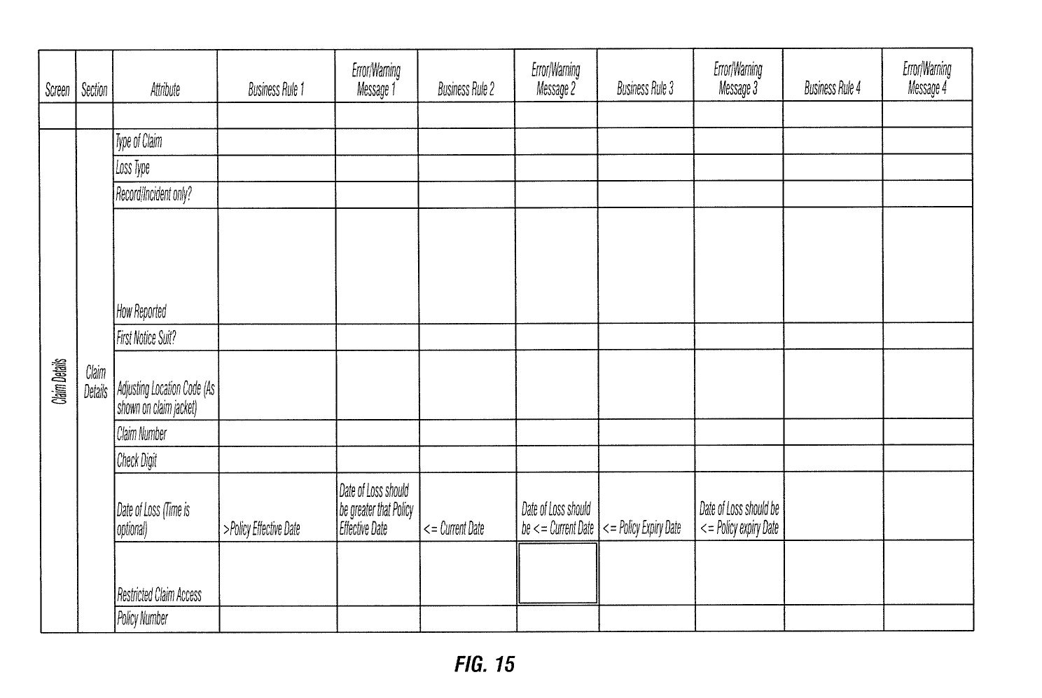

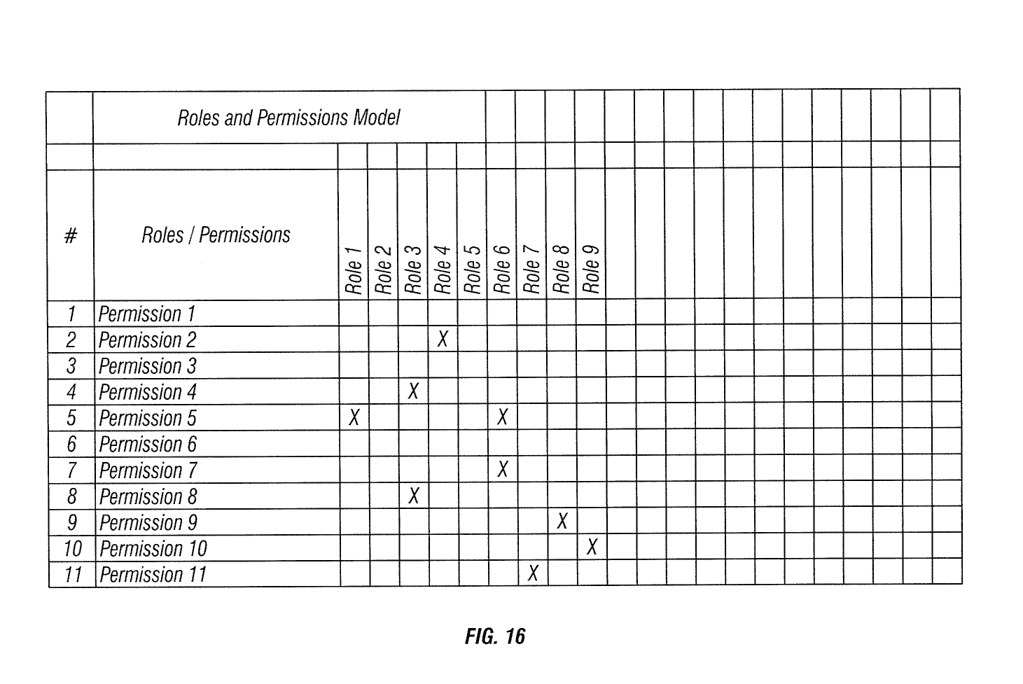

With the above screen/field configurations, the utility developed will parse through the field names, possible values, etc, and will create test cases for positive flow of the module. Since there will be several fields with multiple values, testing the flow with different data set combinations becomes a mandate for the testing team. At the same time, testing with all the n x n combinations leads to over testing and is a time consuming activity. The system provides logic that ensures that each value from all fields is used in the test data set combinations at least once. This logic uses the test data combinations and creates test cases for positive flow and ensures optimal coverage. Generic negative and alternate flows from the product are captured and base-lined. Using generic BPTR customization framework explained above, test cases for negative and alternate flows may be created for the customization that the organization has done. Using the screen/field configurations, the utility developed will parse through the field names and configurations and will create test cases for testing the UI and fields present in the screens. FIG. 14 is the sample of test cases generated for field validations. After associating the business rules with each of the fields as in FIG. 15, the utility developed parses through all the business rules and the associated error messages and will create test cases to test the business rules. The utility developed to generate test cases for testing roles and permissions will generate test cases to test the permissions associated with the roles as shown in FIG. 16.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A computer system comprising:
a memory;
a processor electrically coupled with the memory;
wherein the memory has a machine-executable code stored thereon that causes the processor to:
generate a business process diagram representative of a process flow for a business process, wherein the business process diagram includes a plurality of decision points in the business process;
derive a matrix of business artifacts representative of each possible process flow and decision point in the business process; and
develop a plurality of test cases based on the matrix of business artifacts.

2. The computer system as recited in claim 1, wherein the business process diagram includes one or more of entities, actors, tasks, sequence of tasks, message flow across entities, and data flow across tasks in the business process

3. The computer system as recited in claim 1, further including code for developing a plurality of scenarios that could be encountered in the business process from the matrix.

4. The computer system as recited in claim 1, wherein the matrix includes at least one actor.

5. The computer system as recited in claim 4, wherein the actor is a customer.

6. The computer system as recited in claim 1, wherein the test cases include an identification of test scenarios for flows that need to be validated.

7. The computer system as recited in claim 1, wherein each of the test cases are linked with respective test data

8. The computer system as recited in claim 1, further comprising code for converting at least a portion of the test cases from generic test cases to product specific test cases.

9. The computer system as recited in claim 8, further comprising code for converting from generic test cases to product specific test cases by retrieving a unique test list and generating product related test cases.

10. The computer system as recited in claim 9, wherein each test step in the unique test list corresponding with an expected result for an action to be performed in the test step.

11. The computer system as recited in claim 10, further comprising code for mapping an action a user need to perform to achieve the expected result.

12. The computer system as recited in claim 11, further comprising code for providing a user interface from which a user can define field configurations for at least a portion of the test cases.

13. The computer system as recited in claim 1, wherein the business process diagram is generated based on a functional analysis of a product to identify interactions between screens and modules.

14. The computer system as recited in claim 1, wherein deriving a matrix of business artifacts includes receiving one or more of field configurations, business rules and roles for a module as input.

15. The computer system as recited in claim 14, wherein test cases are developed for one or more of positive flow, negative flow, field validations, business rules validation, and roles validation.

16. The computer system as recited in claim 15, wherein test cases are developed by parsing through field names to create test cases for testing positive flow.

17. The computer system as recited in claim 15, wherein test cases are developed by parsing through field names to create test cases for testing field validation.

18. The computer system as recited in claim 15, wherein test cases are developed by parsing through field names to create test cases for testing business rules.

19. The computer system as recited in claim 15, wherein test cases are developed by parsing through field names to create test cases for testing permissions.

20. The computer system as recited in claim 15, wherein test cases are developed by parsing through field names to create test cases for testing customization of a module.
